(19) United States
(12) Patent Application Publication
(10) Pub. No.: US 2026/0084759 A1
(43) Pub. Date: Mar. 26, 2026

(54) VEHICLE LOWER BODY STRUCTURE

(71) Applicant: MAZDA MOTOR CORPORATION, Hiroshima (JP)

(72) Inventor: Harumitsu KUBOTA, Hiroshima (JP)

(73) Assignee: MAZDA MOTOR CORPORATION, Hiroshima (JP)

(21) Appl. No.: 19/303,808

(22) Filed: Aug. 19, 2025

(30) Foreign Application Priority Data
Sep. 20, 2024 (JP) 2024-163861

(51) Int. Cl. B62D 25/20

(52) U.S. Cl. CPC B62D 25/2036

(57) ABSTRACT

A vehicle lower body structure attaching console accessories and ensuring front collision performance includes a tunnel having left and right ridgeline portions at a center position in a vehicle width direction, left and right side sills, a first floor cross member coupling the side sills, and a console bracket in an opened cross-sectional shape covering the tunnel from a vehicle upper side on a vehicle front side of the first floor cross member, opened downward in the vehicle, and extending in a vehicle front-rear direction. The console bracket has left and right first portions protruding upward along the left and right ridgeline portions to which the console accessories are attached on upper surface portions; and a second portion located between the first portions lower in the vehicle than the upper surface portions of the first portions. The second portion is fixed to the tunnel and the first floor cross member.

### TECHNICAL FIELD

The present disclosure relates to a vehicle lower body structure that includes a tunnel portion extending in the vehicle front-rear direction substantially at the center of a floor panel in a vehicle width direction.

### BACKGROUND

Recently, there has been known a structure in which a console bracket for attaching console accessories, such as a shift lever and an electric component, to an upper surface thereof is fixed to a pair of left and right side sills extending in the vehicle front-rear direction at both lateral ends in a vehicle width direction of a floor panel and to a cross member coupling the pair of left and right side sills in the vehicle width direction (see, WO 2023/181263).

A body structure disclosed in WO 2023/181263 includes: a front cross member disposed on a vehicle front side; a rear cross member disposed on a vehicle rear side of the front cross member; a convex tunnel portion extending in the vehicle front-rear direction from the dash panel to the front cross member; and the console bracket extending in the vehicle front-rear direction from the tunnel portion to the rear cross member.

Then, as described above, in order to attach the console accessories to an upper surface, the console bracket has to be disposed on a vehicle upper side at a predetermined height from the floor panel and is fixed to each of the tunnel portion, the front cross member, and the rear cross member by leg portions extending in a vehicle up-down direction in a manner to cover a battery disposed between the front cross member and the rear cross member from the vehicle upper side.

Since the thus-configured console bracket is fixed to the tunnel portion, the front cross member, and the rear cross member from above by the leg portions extending in the vehicle up-down direction in the manner to cover the battery from the vehicle upper side, the upper surface thereof is disposed higher than the battery, and the console accessories can be attached to the upper surface thereof.

Meanwhile, for example, a collision load from a vehicle front side has to be transmitted from the tunnel portion to the vehicle rear side via the cross members and the side sills. However, since the console bracket in WO 2023/181263 is fixed to each of the tunnel portion, the front cross member, and the rear cross member by the leg portions extending in the vehicle up-down direction from above, it cannot be said that the collision load from the vehicle front side is efficiently transmitted to the cross members, and thus there is room for improvement.

### SUMMARY

In view of the above-described problem, the disclosure provides a vehicle lower body structure capable of attaching console accessories and ensuring desired front collision performance.

The disclosure relates to a vehicle lower body structure having a floor panel, a tunnel portion protruding upward in a vehicle at the center position in a vehicle width direction of the floor panel, and a pair of left and right ridgeline portions extending in a vehicle front-rear direction. A pair of left and right side sills extend in the vehicle front-rear direction at opposing lateral ends in the vehicle width direction of the floor panel; a cross member couples the pair of left and right side sills in the vehicle width direction across the tunnel portion and is fixed to an upper surface of the floor panel; and a console bracket has an opened cross-sectional shape covering the tunnel portion from a vehicle upper side on a vehicle front side of the cross member, opening downward in the vehicle, and extending in the vehicle front-rear direction.

The console bracket has a pair of left and right first portions protruding upward in the vehicle up-down direction along the pair of left and right ridgeline portions and to which console accessories are attached on upper surfaces; and a second portion located between the pair of left and right first portions and located lower in the vehicle up-down direction than the upper surfaces of the first portions, and the second portion is fixed to the tunnel portion and the cross member.

The cross member that couples the above-described pair of left and right side sills in the vehicle width direction across the tunnel portion may have opposing end portions directly connected to the side sills, or may be connected thereto via seat attachment brackets or gussets provided in both end portions. The console accessories include a shift lever, an operation accepting unit (a button), a rotary operation accepting unit, or members supporting these.

According to the disclosure, the vehicle lower body structure can ensure desired front collision performance in a manner to be able to attach the console accessories. More specifically, the vehicle lower body structure is formed with the tunnel portion, which protrudes upward in the vehicle and has the pair of left and right ridgeline portions extending in the vehicle front-rear direction, at the center position in the vehicle width direction of the floor panel, and includes: the cross member coupling the pair of left and right side sills, which extends in the vehicle front-rear direction at opposed lateral ends in the vehicle width direction of the floor panel, in the vehicle width direction across the tunnel portion, and fixed to the upper surface of the floor panel; and the console bracket in the opened cross-sectional shape covering the tunnel portion from the vehicle upper side on the vehicle front side of the cross member, opened downward in the vehicle, and extending in the vehicle front-rear direction.

In addition, the console bracket has the pair of left and right first portions, which protrudes upward in the vehicle along the pair of left and right ridgeline portions of the tunnel portion, and in each of which the console accessories held in the console are attached to the upper surface; and the second portion located between the pair of left and right first portions and located lower in the vehicle than the upper surfaces of the first portions.

Accordingly, the pair of left and right first portions protrudes upward in the vehicle along the pair of left and right ridgeline portions of the tunnel portion protruding upward in the vehicle, and the upper surfaces thereof can be located at predetermined heights from the floor panel. Thus, the console accessories attached to the upper surfaces of the first portions can be held at the appropriate heights.

Meanwhile, the second portion located between the pair of left and right first portions and located lower in the vehicle than the upper surfaces of the first portions is fixed to the tunnel portion and the cross member. Accordingly, the tunnel portion and the cross member are connected in a manner capable of transmitting a load without affecting attachment of the console accessories.

Therefore, in the vehicle lower body structure, in cooperation with the tunnel portion, the console bracket can function as a load transmission member that smoothly transmits the collision load from the vehicle front side to the vehicle rear side via the cross member and the side sills. In this way, the vehicle lower body structure, which includes the console bracket having the second portion fixed to the tunnel portion and the cross member, can ensure the desired front collision performance while attaching the console accessories at the predetermined heights.

As an aspect of the disclosure, a flange fixed to the floor panel may be provided on the vehicle front side of the cross member, and the first portions of the console bracket may be fixed to the flange of the cross member. Fixing the first portions to the flange of the cross member described above means fixing a flange on an outer side in the vehicle width direction provided to each of the first portions or fixing a part of each of the first portions to the flange of the cross member, and may be fastening or fixing by a bolt, fixing by a rivet, or fixing by welding such as spot welding.

According to the disclosure, in the vehicle lower body structure, the first portion is fixed to the cross member. As a result, it is possible to improve the rigidity of the console bracket against the collision load from the vehicle front side input from the tunnel portion. Therefore, the vehicle lower body structure can reliably transmit the collision load from the vehicle front side input from the tunnel portion to the cross member.

As an aspect of the disclosure, a flange fixed to the floor panel may be provided on the vehicle front side of the cross member, and the second portion of the console bracket may be fixed to the flange of the cross member. Fixing the second portion to the flange of the cross member described above may be fastening and fixing by a bolt, fixing by a rivet, or fixing by welding such as spot welding.

According to the disclosure, in the vehicle lower body structure, the second portion can be connected to the cross member via the flange provided on the vehicle front side to fix the cross member to the floor panel. Therefore, the second portion can be connected to the cross member with a simple structure and simple assembly.

In this way, in the vehicle lower body structure, the collision load from the vehicle front side input from the tunnel portion can be input to the cross member from the flange, and can be transmitted smoothly to the vehicle rear side via the cross member and the side sills.

As an aspect of the disclosure, an upper surface of the tunnel portion may have a tunnel inclined portion inclined upward in the vehicle up-down direction to the vehicle front side; and a tunnel rear portion disposed on the vehicle rear side of the tunnel inclined portion and extending along the vehicle front-rear direction, the console bracket may be disposed at a position covering a tunnel bent portion located between the tunnel inclined portion and the tunnel rear portion, and the second portion may be connected to the tunnel inclined portion.

According to the disclosure, in the vehicle lower body structure, the second portion of the console bracket, which covers the tunnel portion from the vehicle upper side on the vehicle front side of the cross member, is connected to the tunnel inclined portion, and covers the tunnel bent portion formed between the tunnel inclined portion and the tunnel rear portion.

As a result, in the vehicle lower body structure, in a portion located between the tunnel inclined portion and the tunnel rear portion and formed with the tunnel bent portion, an inclination angle thereof in a vertical cross section along the vehicle front-rear direction is changed, and thus the rigidity of the tunnel portion in the vehicle front-rear direction is likely to be reduced. However, the second portion connected to the tunnel inclined portion and the cross member covers the tunnel bent portion, the rigidity of which is likely to be reduced.

Therefore, in the vehicle lower body structure, the second portion, which is connected to the tunnel inclined portion and the flange of the cross member, can smoothly transmit the collision load from the vehicle front side to the vehicle rear side from the tunnel portion via the cross member and the side sills while the tunnel portion, the rigidity of which against the collision load from the vehicle front side is low, is reinforced by the console bracket.

As an aspect of the disclosure, the second portion may have a front portion extending along the vehicle front-rear direction and separated upward in the vehicle up-down direction from the upper surface of the tunnel portion; and a rear inclined portion disposed on the vehicle rear side of the front portion and inclined downward in the vehicle up-down direction to the vehicle rear side.

According to the disclosure, in the vehicle lower body structure, the front portion of the second portion disposed lower in the vehicle than the upper surfaces of the first portions is separated upward in the vehicle from the upper surface of the tunnel portion, and the rear inclined portion is inclined toward the flange of the cross member.

As a result, compared to a case where the front portion of the second portion is inclined along the tunnel inclined portion, in the vehicle lower body structure, the front portion can secure a cross-sectional area along the vehicle width direction. Therefore, the vehicle lower body structure can improve body rigidity against the collision load from the vehicle front side.

Meanwhile, compared to a case where a rear portion of the console bracket extends in the vehicle up-down direction, in the vehicle lower body structure, the rear inclined portion of the second portion can make a connection direction to the cross member gradual. In this way, the collision load from the vehicle front side input from the tunnel inclined portion can smoothly be transmitted to the cross member. Therefore, in the vehicle lower body structure, together with the tunnel portion, the collision load from the vehicle front side input to the tunnel portion can smoothly be transmitted to the vehicle rear side via the cross member and the side sills.

As an aspect of the disclosure, a bent portion formed between the front portion of the second portion and the rear inclined portion of the second portion may be disposed at a different position in the vehicle front-rear direction from the tunnel bent portion.

According to the disclosure, in the vehicle lower body structure, the bent portion of the console bracket and the tunnel bent portion with low rigidity against the collision load from the vehicle front side do not match with each other in the vehicle front-rear direction.

Therefore, the vehicle lower body structure can improve the body rigidity near the tunnel bent portion against the collision load from the vehicle front side. Therefore, the vehicle lower body structure can further efficiently transmit the collision load from the vehicle front side to the vehicle rear side.

As an aspect of the disclosure, a bent portion formed between the front portion of the second portion and the rear inclined portion of the second portion may be disposed on the vehicle front side of the tunnel bent portion. Thus, in the vehicle lower body structure, the length of the rear inclined portion can be set to be longer.

Accordingly, an inclination angle of the rear inclined portion can be set to be gentle, that is, an angle of the bent portion in the console bracket can be set to be large. In this way, compared to a case where the inclination angle of the rear inclined portion is steep, in the vehicle lower body structure, the rigidity of the console bracket can be improved. Therefore, the vehicle lower body structure can smoothly and efficiently transmit the collision load from the vehicle front side to the vehicle rear side.

As an aspect of the disclosure, when viewed from the vehicle front-rear direction, the first portion may overlap the cross member. According to the disclosure, in the vehicle lower body structure, the first portions on both sides in the vehicle width direction of the second portion are disposed on the vehicle front side of the cross member.

Thus, in the vehicle lower body structure, a position in the vehicle up-down direction of an axis of the center of gravity of the console bracket along the vehicle front-rear direction in a vertical cross section in the vehicle width direction of the console bracket can approximate that of an axis of the center of gravity of the cross member along the vehicle width direction in the vertical cross section in the vehicle front-rear direction of the cross member.

In this way, in the vehicle lower body structure, the collision load from the vehicle front side can smoothly be transmitted between the second portion and the cross member connected via the flange and can further efficiently be transmitted to the vehicle rear side via the cross member and the side sills.

In addition, in the vehicle lower body structure, the first portions on both sides in the vehicle width direction of the second portion are disposed on the vehicle front side of the cross member. Accordingly, even when the tunnel portion is attempted to move rearward during a frontal collision, the rearward movement of the tunnel portion can be prevented by the console bracket and the cross member. At this time, since the collision load from the vehicle front side can be transmitted to the cross member via the first portions in addition to the second portion, the vehicle lower body structure can reliably prevent the rearward movement of the tunnel portion.

As an aspect of the disclosure, the first portion may be fixed to the tunnel portion or proximal the tunnel portion. According to the disclosure, in the vehicle lower body structure, the first portions on both sides in the vehicle width direction of the console bracket can be fixed to the tunnel portion or proximal the tunnel portion as part of the front floor panel.

In this way, in the vehicle lower body structure, the console bracket can firmly be fixed to the floor panel, and the rigidity of the floor panel and the console bracket can be improved. Therefore, the vehicle lower body structure can suppress vibration generated to the console bracket and the front floor panel.

The disclosure can provide the vehicle lower body structure capable of attaching the console accessories and ensuring the desired front collision performance.

### BRIEF DESCRIPTION OF THE DRAWINGS

FIG. 1 is an external perspective view illustrating external appearance of a vehicle lower body as viewed from a vehicle rear side.

FIG. 2 is a plan view illustrating the external appearance of the vehicle lower body in a plan view.

FIG. 3 is an enlarged plan view of a main section in FIG. 2.

FIG. 4 is an external perspective view illustrating external appearance of the main section in the vehicle lower body as viewed from the vehicle rear side.

FIG. 5A is a cross-sectional view that is taken along an arrow B-B in FIG. 3, FIG. 5B is a cross-sectional view that is taken along an arrow C-C in FIG. 3, and FIG. 5C is a cross-sectional view that is taken along an arrow D-D in FIG. 3

FIG. 6 is a cross-sectional view that is taken along an arrow A-A in FIG. 2.

### DETAILED DESCRIPTION

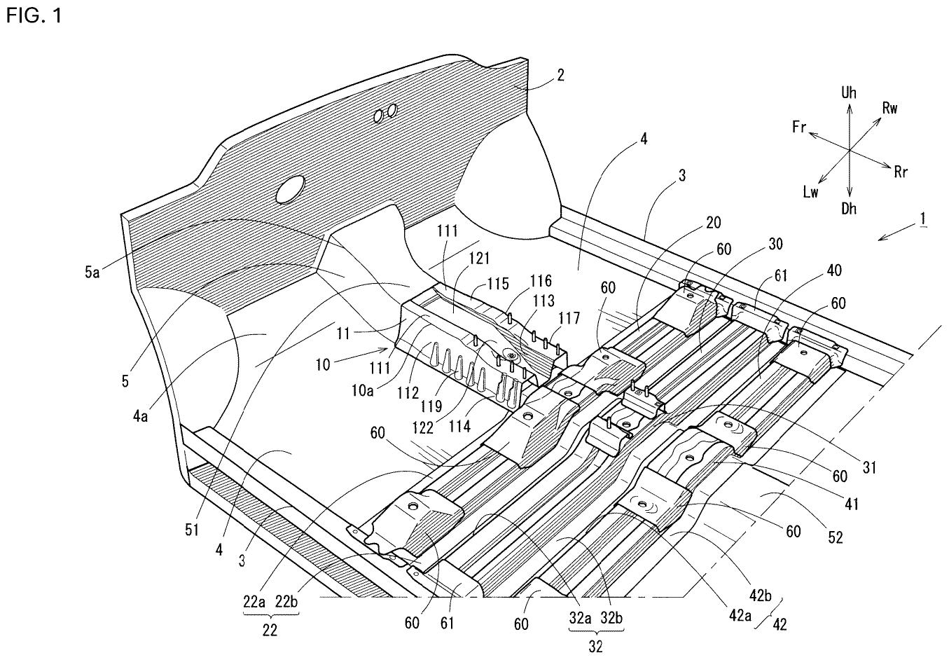

An embodiment of the disclosure will be described below with reference to the drawings. A vehicle in this embodiment is, for example, a vehicle that includes a portion extending in the vehicle front-rear direction at substantially the center of a floor panel in a vehicle width direction. A lower body structure in a cabin portion of such a vehicle 1 will be described in detail with reference to FIG. 1 to FIG. 6.

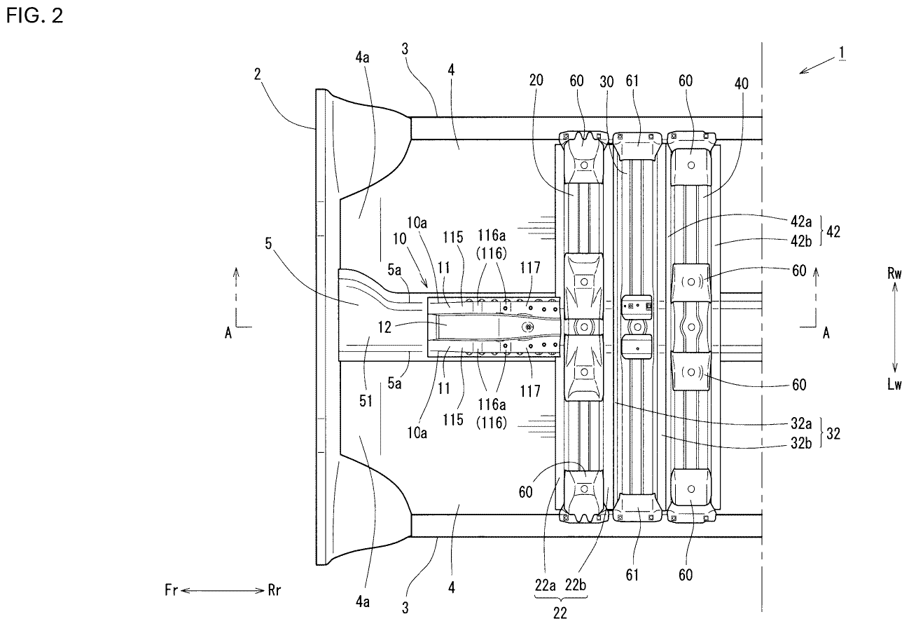

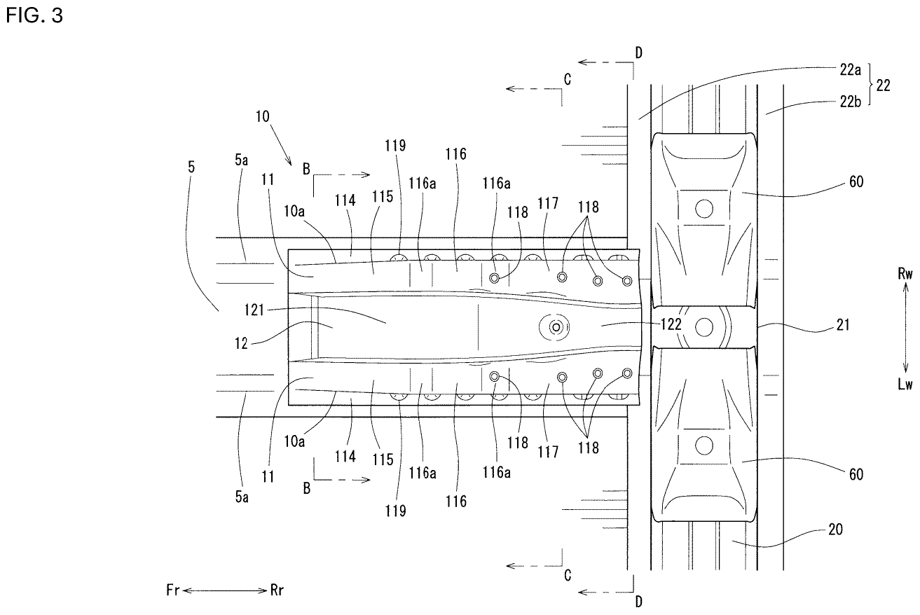

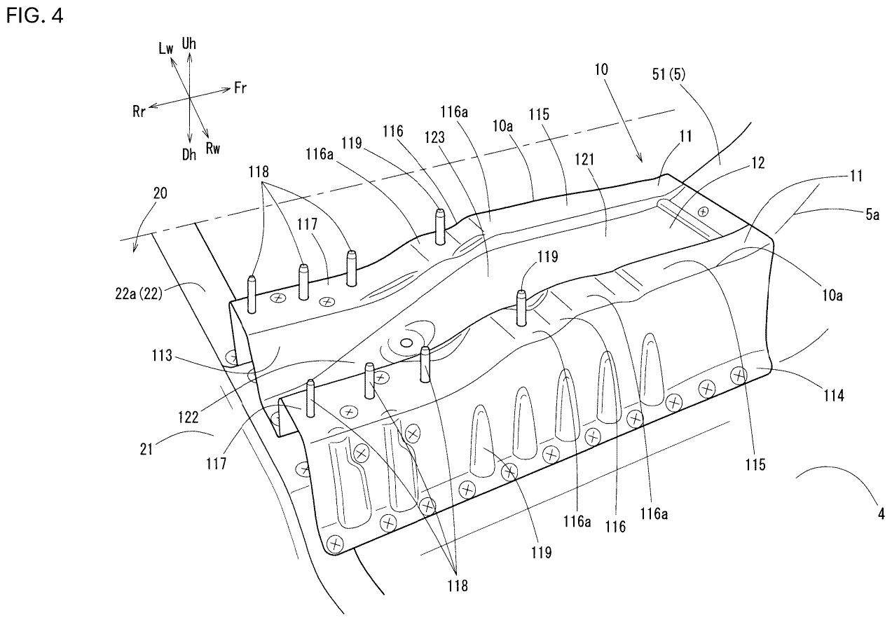

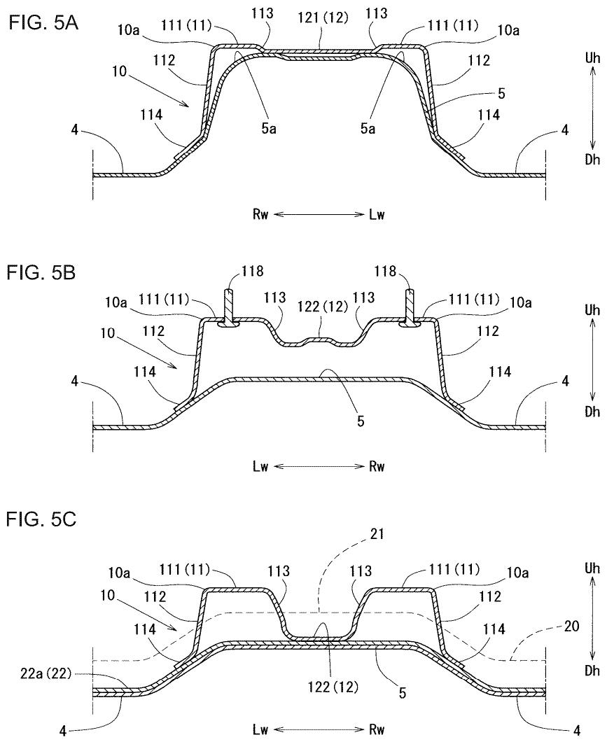

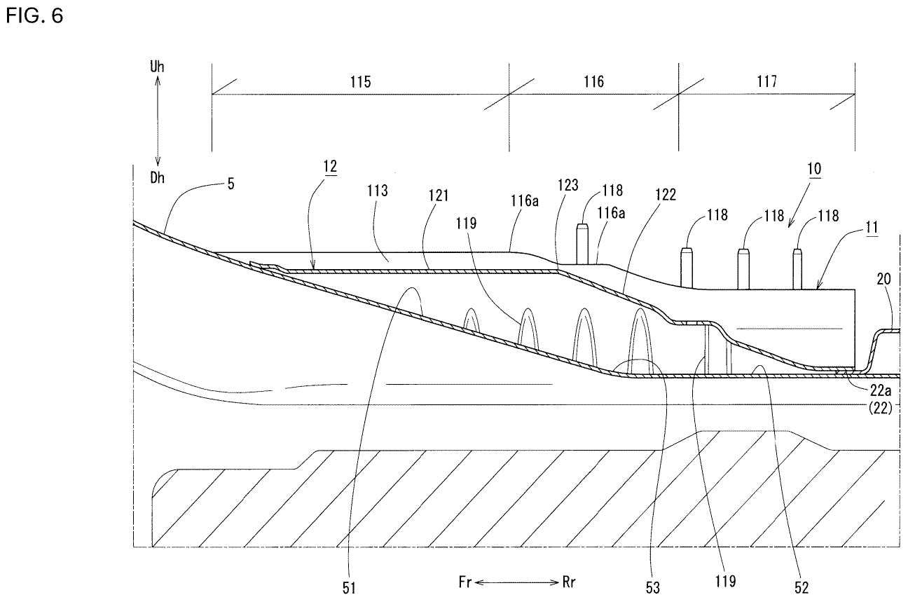

Here, FIG. 1 is an external perspective view illustrating external appearance of a lower body of the vehicle 1 as viewed from a vehicle rear side, FIG. 2 is a plan view of the lower body of the vehicle 1, FIG. 3 is an enlarged plan view of a main section in FIG. 2, FIG. 4 is an external perspective view illustrating the main section in the lower body of the vehicle 1 as viewed from the vehicle rear side, FIGS. 5A-5C are each cross-sectional views taken along an arrow in FIG. 3, and FIG. 6 is a cross-sectional view of the main section that is taken along an arrow A-A in FIG. 2.

In detail, FIG. 5A is a cross-sectional view that is taken along an arrow B-B in FIG. 3, FIG. 5B is a cross-sectional view that is taken along an arrow C-C in FIG. 3, and FIG. 5C is a cross-sectional view that is taken along an arrow D-D in FIG. 3.

In the drawings, arrows Fr and Rr indicate the front-rear direction, an arrow Fr indicates a front direction, and an arrow Rr indicates a rear direction. Arrows Rw and Lw indicate the vehicle width direction, an arrow Rw indicates a right direction, and an arrow Lw indicates a left direction. Furthermore, arrows Uh and Dh indicate a vehicle up-down direction, an arrow Uh indicates a vehicle up direction, and an arrow Dh indicates a vehicle down direction.

As illustrated in FIGS. 1 and 2, the lower body of the vehicle 1 includes: a dash panel 2 that separates an engine room and the cabin in the vehicle front-rear direction; a pair of left and right side sills 3 extending rearward in the vehicle from lower portions at both ends of the dash panel 2 in the vehicle width direction; and a front floor panel 4 disposed between the left and right side sills 3 and forms a cabin floor surface.

Furthermore, as illustrated in FIGS. 1 and 2, the lower body of the vehicle 1 is formed with a tunnel portion 5 bulging substantially in a tunnel shape extending from the vehicle front side to the vehicle rear side in the vicinity of substantially the center in the vehicle width direction, and includes floor cross members 20, 30, 40 near the center in the vehicle front-rear direction. In addition, a console bracket 10 in a mode covering the tunnel portion 5 is provided on the vehicle front side of the first floor cross member 20.

In the lower body of the vehicle 1, the first floor cross member 20, the second floor cross member 30, and the third floor cross member 40, each of which couples the left and right side sills 3 in the vehicle width direction, are provided in this order from the vehicle front side toward the vehicle rear side.

More specifically, the dash panel 2 is a panel member having a thickness in the vehicle front-rear direction, and a lower portion thereof is formed in a shape curved toward the vehicle rear side. From a lower end of this dash panel 2, the front floor panel 4 is provided to extend rearward in the vehicle.

The side sills 3 are provided as the left and right pair extending rearward in the vehicle from the lower portions at both ends of the dash panel 2 in the vehicle width direction, and are each configured such that a cross-sectional shape in a vertical cross section along the vehicle width direction have a substantially rectangular closed cross section.

In detail, in the vertical cross section along the vehicle width direction, each of the side sills 3 includes: a side sill outer (not illustrated) having a substantially hat-shaped cross section protruding outward in the vehicle width direction; and a side sill inner (not illustrated) having a substantially hat-shaped cross section protruding inward in the vehicle width direction.

As illustrated in FIGS. 1 to 5, the front floor panel 4 is a substantially flat panel member having a thickness in the vehicle up-down direction, and a front end thereof is coupled to the lower end of the dash panel 2. A vehicle front portion of the front floor panel 4 is a floor inclined portion 4a that is inclined upward in the vehicle to the vehicle front side toward the dash panel 2.

In addition, the tunnel portion 5 protruding upward in the vehicle is formed substantially at the center in the vehicle width direction of the front floor panel 4. Here, in the tunnel portion 5, an end portion thereof on the vehicle front side is joined to the dash panel 2, and an upper surface thereof is inclined downward in the vehicle to the vehicle rear side toward the first floor cross member 20, which will be described below.

In detail, on the vehicle front side of the first floor cross member 20, which will be described below, the upper surface of the tunnel portion 5 has: a tunnel inclined portion 51 that is inclined downward in the vehicle to the vehicle rear side; and a tunnel rear portion 52 that is disposed on the vehicle rear side of the tunnel inclined portion 51 and extends substantially horizontally along the vehicle front-rear direction, and a tunnel bent portion 53 is provided between the tunnel inclined portion 51 and the tunnel rear portion 52. An upper surface of the tunnel rear portion 52 is disposed higher at a predetermined height in the vehicle than the front floor panel 4. In an upper portion of this tunnel portion 5, a pair of left and right ridgeline portions 5a extending in the vehicle front-rear direction at a predetermined distance in the vehicle width direction is formed.

The floor cross members 20, 30, 40 couple the pair of left and right side sills 3 in the vehicle width direction across the tunnel rear portion 52 of the tunnel portion 5 extending in the vehicle front-rear direction, and are disposed in this order from the vehicle front side toward the vehicle rear side. That is, at a position near the center in the vehicle front-rear direction of the front floor panel 4, the floor cross members 20, 30, 40 each couple the left and right side sills 3 substantially linearly. The floor cross members 20, 30, 40 are each formed to have a substantially M-shaped cross section extending in the vehicle width direction.

As illustrated in FIGS. 1 and 2, the first floor cross member 20 is disposed on the vehicle front side of the second floor cross member 30 and is provided to extend in the vehicle width direction across the tunnel portion 5. In addition, at the center in the vehicle width direction, the first floor cross member 20 has a crossing section 21 extending across the tunnel portion 5. Compared to the other portions, the crossing section 21 is formed to bulge upward in the vehicle along the tunnel portion 5. Furthermore, the first floor cross member 20 includes four seat brackets 60 on outer sides in the vehicle width direction of the crossing section 21 and in both end portions in the vehicle width direction of the first floor cross member 20 to attach a front seat (not illustrated), and is joined to the pair of left and right side sills 3 by the seat brackets 60 in both end portions in the vehicle width direction. Here, the seat brackets 60 and the side sills 3 are joined and fixed by welding such as spot welding.

Furthermore, on both sides in the vehicle front-rear direction of the first floor cross member 20, cross member flanges 22 extending in the vehicle front-rear direction are provided along the vehicle width direction, and the cross member flanges 22 are joined and fixed to the front floor panel 4. Here, the cross member flanges 22 are fixed to upper surfaces of the side sills 3 by spot welding or the like. In addition, the cross member flanges 22 in the crossing section 21 of the first floor cross member 20 are joined and fixed to the tunnel portion 5 constituting the front floor panel 4.

In detail, of the cross member flanges 22 in the vehicle front-rear direction, a front flange 22a disposed on the vehicle front side is directly fixed to the front floor panel 4, and a rear flange 22b disposed on the vehicle rear side is disposed above a front flange 32a of the second floor cross member 30, which will be described below, in the vehicle and is fixed to the upper surface of the front floor panel 4 via the front flange 32a.

Thus, in the vertical cross section along the vehicle front-rear direction, together with the front floor panel 4, the first floor cross member 20 is formed in a shape having a closed cross section extending in the vehicle width direction. In addition, an upper surface of the first floor cross member 20 joined to the side sills 3 and the upper surfaces of the side sills 3 are located at substantially the same height.

As illustrated in FIGS. 1 and 2, the second floor cross member 30 is disposed on the vehicle rear side of the first floor cross member 20, disposed on the vehicle front side of the third floor cross member 40, and is provided to extend in the vehicle width direction across the tunnel portion 5.

In addition, similar to the first floor cross member 20, at the center in the vehicle width direction, the second floor cross member 30 has a crossing section 31 extending across the tunnel portion 5. Compared to the other portions, the crossing section 31 is formed to bulge upward in the vehicle along the tunnel portion 5. Furthermore, the second floor cross member 30 includes a pair of gussets 61 for being joined to the side sills 3 in both end portions in the vehicle width direction, and is joined to a pair of the left and right side sills 3 by the gussets 61 in both end portions in the vehicle width direction. Here, the gussets 61 and the side sills 3 are joined and fixed by welding such as spot welding.

Furthermore, on both sides in the vehicle front-rear direction of the second floor cross member 30, cross member flanges 32 extending in the vehicle front-rear direction are provided along the vehicle width direction, and the cross member flanges 32 are joined and fixed to the front floor panel 4. Here, the cross member flanges 32 are fixed to the upper surfaces of the side sills 3 by spot welding or the like.

In detail, of the cross member flanges 32 in the vehicle front-rear direction, as described above, the front flange 32a disposed on the vehicle front side is covered with the rear flange 22b of the first floor cross member 20 from above and fixed to the front floor panel 4, and a rear flange 32b disposed on the vehicle rear side is disposed above a front flange 42a of the third floor cross member 40, which will be described below, in the vehicle and is fixed to the upper surface of the front floor panel 4 via the front flange 42a.

Thus, in the vertical cross section along the vehicle front-rear direction, together with the front floor panel 4, the second floor cross member 30 is formed in a shape having a closed cross section extending in the vehicle width direction. In addition, the upper surface of the second floor cross member 30 joined to the side sills 3 and the upper surfaces of the side sills 3 are located at substantially the same height.

As illustrated in FIGS. 1 and 2, the third floor cross member 40 is disposed on the vehicle rear side of the second floor cross member 30 and is provided to extend in the vehicle width direction across the tunnel portion 5. In addition, at the center in the vehicle width direction, the third floor cross member 40 has a crossing section 41 extending across the tunnel portion 5. Compared to the other portions, the crossing section 41 is formed to bulge upward in the vehicle along the tunnel portion 5. Furthermore, the third floor cross member 40 includes four seat brackets 60 on outer sides in the vehicle width direction of the crossing section 41 and in both end portions in the vehicle width direction of the third floor cross member 40 to attach the front seat (not illustrated), and is joined to the pair of left and right side sills 3 by the seat brackets 60 in both end portions in the vehicle width direction. Here, the seat brackets 60 and the side sills 3 are joined and fixed by welding such as spot welding.

Furthermore, on both sides in the vehicle front-rear direction of the third floor cross member 40, cross member flanges 42 extending in the vehicle front-rear direction are provided along the vehicle width direction, and the cross member flanges 42 are joined and fixed to the front floor panel 4. Here, the cross member flanges 42 are fixed to the upper surfaces of the side sills 3 by spot welding or the like.

In detail, of the cross member flanges 42 in the vehicle front-rear direction, as described above, the front flange 42a disposed on the vehicle front side is covered with the rear flange 32b of the second floor cross member 30 from above and fixed to the front floor panel 4, and a rear flange 42b disposed on the vehicle rear side is directly fixed to the upper surface of the front floor panel 4.

Thus, in the vertical cross section along the vehicle front-rear direction, together with the front floor panel 4, the third floor cross member 40 is formed in a shape having a closed cross section extending in the vehicle width direction. In addition, an upper surface of the third floor cross member 40 joined to the side sills 3 and the upper surfaces of the side sills 3 are located at substantially the same height.

The console bracket 10 is a bracket for attaching console accessories (not illustrated) and, in the vehicle front-rear direction, is disposed to cover the tunnel portion 5 from the vicinity of the center of the tunnel inclined portion 51 in the tunnel portion 5 to the vehicle front side of the first floor cross member 20 from above in the vehicle. Here, the console accessories include a shift lever, an operation accepting unit (a button), a rotary operation accepting unit, members supporting these, and the like.

As illustrated in FIGS. 5A-5C, the console bracket 10 is formed with, in an upper portion, a pair of left and right ridgeline portions 10a extending in the vehicle front-rear direction at a predetermined interval in the vehicle width direction, and, in a vertical cross section along the vehicle width direction, is formed to have an open cross section opened downward in a substantially inverted concave shape in the vehicle.

In detail, in the vertical cross section along the vehicle width direction, the console bracket 10 includes: a pair of first portions 11 disposed on both outer sides in the vehicle width direction and having the ridgeline portions 10a; and a second portion 12 disposed between the first portions 11 and disposed lower in the vehicle than upper surface portions 111 of the first portions 11.

In the vertical cross section along the vehicle width direction, the first portion 11 includes: the substantially horizontal upper surface portion 111; an outer surface portion 112 extending downward in the vehicle on an outer side in the vehicle width direction of the upper surface portion 111; and an inner surface portion 113 extending downward in the vehicle on an inner side in the vehicle width direction of the upper surface portion 111. In addition, at a lower end of the outer surface portion 112, a bracket flange 114 is provided to be fixed to a side surface of the tunnel portion 5 constituting a part of the front floor panel 4.

Here, the ridgeline portion 10a is formed by a corner portion between the upper surface portion 111 and the outer surface portion 112, and the ridgeline portion 10a is formed by a corner portion between the upper surface portion 111 and the inner surface portion 113. As will be described below, the ridgeline portion 10a formed by the corner portion between the upper surface portion 111 and the outer surface portion 112 is provided along a ridgeline portion 5a of the tunnel portion 5.

As illustrated in FIG. 4, from the vehicle front side toward the vehicle rear side, the upper surface portion 111 has: a first front portion 115 substantially horizontal in the vehicle front-rear direction; a first inclined portion 116 that is lowered downward in the vehicle in a substantially step shape in the vehicle rear direction; and a first rear portion 117 substantially horizontal in the vehicle front-rear direction. In the first inclined portion 116 lowered downward in the vehicle in the substantially step shape in the vehicle rear direction, a horizontal placement portion 116a, which is substantially horizontal, is provided at two positions at an interval in the vehicle front-rear direction. However, the ridgeline portion 10a passing through the horizontal placement portions 116a, each of which is substantially horizontal, is formed to be smoothly continuous. In addition, in the horizontal placement portions 116a of the first inclined portion 116 and the first rear portion 117, weld bolts 118 protruding upward in the vehicle are provided to attach the console accessories.

Furthermore, in the outer surface portion 112 as the outer side in the vehicle width direction of the first portion 11, ribs 119 are provided to bulge outward in the vehicle width direction and extend in the vehicle up-down direction. In detail, in the outer surface portion 112, portions corresponding to the first inclined portion 116 and the first rear portion 117 in the upper surface portion 111 are provided with the plural ribs 119 at predetermined intervals in the vehicle front-rear direction.

Meanwhile, the inner surface portion 113 is an inclined surface that is inclined inward in the vehicle width direction to the bottom of the vehicle, and, on the vehicle rear side of the first front portion 115, is formed to be longer in an inclined direction to the rear of the vehicle.

In the vertical cross section along the vehicle width direction, the second portion 12 is formed substantially horizontally in a manner to couple lower ends of the inner surface portions 113 in the first portions 11 provided on both sides in the vehicle width direction. Accordingly, the second portion 12 is disposed above the upper surface of the tunnel portion 5 and lower in the vehicle than the upper surface portions 111 of the first portions 11. As illustrated in FIG. 6, the second portion 12 has: a second front portion 121 substantially horizontal in the vehicle front-rear direction; and a second rear inclined portion 122 inclined downward in the vehicle to the rear of the vehicle.

In detail, the second front portion 121 of the second portion 12 is formed at a position corresponding to the first front portion 115 of the first portion 11 in the vehicle front-rear direction, and the second rear inclined portion 122 is formed at a position corresponding to the first inclined portion 116 and the first rear portion 117 in the first portion 11. In addition, a bracket bent portion 123 is provided between the second front portion 121 and the second rear inclined portion 122.

An end portion on a vehicle front side of the second front portion 121 in the second portion 12 is joined to the tunnel inclined portion 51 of the tunnel portion 5, and an end portion on the vehicle rear side of the second rear inclined portion 122 is joined and fixed to the front flange 22a of the crossing section 21 in the first floor cross member 20 joined and fixed to the tunnel portion 5. Here, the second portion 12 is joined and fixed to each of the tunnel inclined portion 51 and the front flange 22a by welding such as spot welding.

Furthermore, the bracket flange 114 provided at the lower end of the outer surface portion 112 in the first portion 11 is joined and fixed to a side surface lower portion of the tunnel portion 5 constituting a part of the front floor panel 4. Here, an end portion on the vehicle rear side of the bracket flange 114 is joined and fixed to the front flange 22a of the crossing section 21 in the first floor cross member 20 joined and fixed to the tunnel portion 5. In addition, the bracket flange 114 and the side surface of the tunnel portion 5 are joined and fixed by welding such as spot welding.

Accordingly, in the vehicle front-rear direction, the console bracket 10, which is configured as described above and in which the second portion 12 is fixed to the tunnel portion 5 and the front flange 22a of the first floor cross member 20, is fixed to cover the tunnel portion 5 from the vicinity of the center of the tunnel inclined portion 51 in the tunnel portion 5 to the vehicle front side of the first floor cross member 20 from above in the vehicle.

At this time, as illustrated in FIGS. 1 to 3, the console bracket 10 is disposed such that the ridgeline portion 10a formed on the outer side in the vehicle width direction of the first portion 11 is provided along the ridgeline portion 5a of the tunnel portion 5. Furthermore, as illustrated in FIGS. 3 and 6, in the vehicle front-rear direction, the console bracket 10 is disposed at a slight distance from a front surface of the first floor cross member 20, and the bracket bent portion 123 of the second portion 12 is disposed on the vehicle front side of the tunnel bent portion 53 of the tunnel portion 5.

In the vertical cross section along the vehicle width direction, the console bracket 10 has the opened cross-sectional shape. However, the closed cross section can be formed by the console bracket 10 and the tunnel portion 5 since the bracket flange 114 provided at a tip of the outer surface portion 112 is joined to the side surface of the tunnel portion 5. As a result, it is possible to improve rigidity of the tunnel portion 5 and the console bracket 10 against a collision load from the vehicle front side.

Furthermore, as illustrated in FIG. 5C, the first portion 11 of the console bracket 10 disposed to cover the tunnel portion 5 from the vehicle upper side overlaps the first floor cross member 20, in which the crossing section 21 is provided across the tunnel portion 5, in the vehicle front-rear direction.

As described so far, the lower body structure of the vehicle 1 is formed with the tunnel portion 5, which protrudes upward in the vehicle and has the pair of left and right ridgeline portions 5a extending in the vehicle front-rear direction, at the center position in the vehicle width direction of the front floor panel 4, and includes: the pair of left and right side sills 3 extending in the vehicle front-rear direction at both lateral ends in the vehicle width direction of the front floor panel 4; the first floor cross member 20 coupling the pair of left and right side sills 3 in the vehicle width direction across the tunnel portion 5 and fixed to the upper surface of the front floor panel 4; and the console bracket 10 in the opened cross-sectional shape covering the tunnel portion 5 from the vehicle upper side on the vehicle front side of the first floor cross member 20, opened downward in the vehicle, and extending in the vehicle front-rear direction. The console bracket 10 has: the pair of left and right first portions 11, which protrudes upward in the vehicle along the pair of left and right ridgeline portions 5a, and in each of which the console accessories are attached to the upper surface portion 111; and the second portion 12 located between the pair of left and right first portions 11 and located lower in the vehicle than the upper surface portions 111 of the first portions 11. The second portion 12 is fixed to the tunnel portion 5 and the first floor cross member 20.

Therefore, the lower body structure of the vehicle 1 can ensure desired front collision performance in a manner to be able to attach the console accessories. More specifically, the lower body structure of the vehicle 1 is formed with the tunnel portion 5, which protrudes upward in the vehicle and has the pair of left and right ridgeline portions 5a extending in the vehicle front-rear direction, at the center position in the vehicle width direction of the front floor panel 4, and includes: the first floor cross member 20 coupling the pair of left and right side sills 3, which extends in the vehicle front-rear direction at both lateral ends in the vehicle width direction of the front floor panel 4, in the vehicle width direction across the tunnel portion 5, and fixed to the upper surface of the front floor panel 4; and the console bracket 10 in the opened cross-sectional shape covering the tunnel portion 5 from the vehicle upper side on the vehicle front side of the first floor cross member 20, opened downward in the vehicle, and extending in the vehicle front-rear direction.

In addition, the console bracket 10 has: the pair of left and right first portions 11, which protrudes upward in the vehicle along the pair of left and right ridgeline portions 5a of the tunnel portion 5, and in each of which the console accessories held in the console are attached to the upper surface portion 111; and the second portion 12 located between the pair of left and right first portions 11 and located lower in the vehicle than the upper surface portions 111 of the first portions 11.

Accordingly, the pair of left and right first portions 11 protrudes upward in the vehicle along the pair of left and right ridgeline portions 5a of the tunnel portion 5 protruding upward in the vehicle, and the upper surface portions 111 thereof can be located at the predetermined height from the front floor panel 4. Thus, the console accessories attached to the upper surface portions 111 of the first portions 11 can be held at appropriate heights.

Meanwhile, the second portion 12 located between the pair of left and right first portions 11 and located lower in the vehicle than the upper surface portions 111 of the first portions 11 is fixed to the tunnel portion 5 and the first floor cross member 20. Accordingly, the tunnel portion 5 and the first floor cross member 20 are connected in a manner capable of transmitting the load without affecting attachment of the console accessories.

Therefore, in the lower body structure of the vehicle 1, in cooperation with the tunnel portion 5, the console bracket 10 can function as a load transmission member that smoothly transmits the collision load from the vehicle front side to the vehicle rear side via the first floor cross member 20 and the side sills 3. In this way, the lower body structure of the vehicle 1, which includes the console bracket 10 having the second portion 12 fixed to the tunnel portion 5 and the first floor cross member 20, can ensure the desired front collision performance while attaching the console accessories at the predetermined heights.

The front flange 22a fixed to the front floor panel 4 is provided on the vehicle front side of the first floor cross member 20, and the first portion 11 is fixed to the front flange 22a of the first floor cross member 20. More specifically, the end portion on the vehicle rear side of the bracket flange 114, which is provided at the lower end of the outer surface portion 112 of the first portion 11, is joined and fixed to the front flange 22a of the first floor cross member 20.

Thus, in the lower body structure of the vehicle 1, the first portion 11 is fixed to the first floor cross member 20. As a result, it is possible to improve the rigidity of the console bracket 10 against the collision load from the vehicle front side input from the tunnel portion 5. Therefore, the lower body structure of the vehicle 1 can reliably transmit the collision load from the vehicle front side input from the tunnel portion 5 to the first floor cross member 20.

The front flange 22a fixed to the front floor panel 4 is provided on the vehicle front side of the first floor cross member 20, and the second portion 12 is fixed to the front flange 22a of the first floor cross member 20.

Accordingly, in the lower body structure of the vehicle 1, the second portion 12 can be joined to the first floor cross member 20 via the front flange 22a provided on the vehicle front side to fix the first floor cross member 20 to the front floor panel 4. Therefore, the second portion 12 can be connected to the first floor cross member 20 with a simple structure and simple assembly.

In this way, in the lower body structure of the vehicle 1, the collision load from the vehicle front side input from the tunnel portion 5 can be input to the first floor cross member 20 from the cross member flange 22, and can be transmitted smoothly to the vehicle rear side via the first floor cross member 20 and the side sills 3.

The upper surface of the tunnel portion 5 has: the tunnel inclined portion 51 inclined upward in the vehicle to the vehicle front side; and the tunnel rear portion 52 disposed on the vehicle rear side of the tunnel inclined portion 51 and extending along the vehicle front-rear direction. The console bracket 10 is disposed at the position covering the tunnel bent portion 53 formed between the tunnel inclined portion 51 and the tunnel rear portion 52. The second portion 12 is connected to the tunnel inclined portion 51.

Accordingly, in the lower body structure of the vehicle 1, the second portion 12 of the console bracket 10, which covers the tunnel portion 5 from the vehicle upper side on the vehicle front side of the first floor cross member 20, is connected to the tunnel inclined portion 51, and covers the tunnel bent portion 53 formed between the tunnel inclined portion 51 and the tunnel rear portion 52.

As a result, in the lower body structure of the vehicle 1, in the portion located between the tunnel inclined portion 51 and the tunnel rear portion 52 and formed with the tunnel bent portion 53, an inclination angle thereof in the vertical cross section along the vehicle front-rear direction is changed, and thus the rigidity of the tunnel portion 5 in the vehicle front-rear direction is likely to be reduced. However, the second portion 12 connected to the tunnel inclined portion 51 and the first floor cross member 20 covers the tunnel bent portion 53, the rigidity of which is likely to be reduced.

Therefore, in the lower body structure of the vehicle 1, the second portion 12, which is connected to the tunnel inclined portion 51 and the cross member flange 22 of the first floor cross member 20, can smoothly transmit the collision load from the vehicle front side to the vehicle rear side from the tunnel portion 5 via the first floor cross member 20 and the side sills 3 while the tunnel portion 5, the rigidity of which against the collision load from the vehicle front side is low, is reinforced by the console bracket 10.

The second portion 12 has: the second front portion 121 extending along the vehicle front-rear direction and separated upward in the vehicle from the upper surface of the tunnel portion 5; and the second rear inclined portion 122 disposed on the vehicle rear side of the second front portion 121 and inclined downward in the vehicle to the vehicle rear side.

Accordingly, in the lower body structure of the vehicle 1, the second front portion 121 of the second portion 12 disposed lower in the vehicle than the upper surface portions 111 of the first portions 11 is separated upward in the vehicle from the upper surface of the tunnel portion 5, and the second rear inclined portion 122 is inclined toward the cross member flange 22 of the first floor cross member 20.

As a result, compared to a case where the second front portion 121 is inclined along the tunnel inclined portion 51, in the lower body structure of the vehicle 1, the second front portion 121 of the second portion 12 can secure a cross-sectional area along the vehicle width direction. Therefore, the lower body structure of the vehicle 1 can improve body rigidity against the collision load from the vehicle front side.

Meanwhile, compared to a case where a rear portion of the console bracket 10 extends in the vehicle up-down direction, in the lower body structure of the vehicle 1, the second rear inclined portion 122 of the second portion 12 can make a connection direction to the first floor cross member 20 gradual. In this way, the collision load from the vehicle front side input from the tunnel inclined portion 51 can smoothly be transmitted to the first floor cross member 20.

Therefore, in the lower body structure of the vehicle 1, together with the tunnel portion 5, the collision load from the vehicle front side input to the tunnel portion 5 can smoothly be transmitted to the vehicle rear side via the first floor cross member 20 and the side sills 3.

The bracket bent portion 123 formed between the second front portion 121 and the second rear inclined portion 122 is disposed at a different position in the vehicle front-rear direction from the tunnel bent portion 53. Accordingly, in the lower body structure of the vehicle 1, the bracket bent portion 123 of the console bracket 10 and the tunnel bent portion 53 with low rigidity against the collision load from the vehicle front side do not match with each other in the vehicle front-rear direction.

Therefore, the lower body structure of the vehicle 1 can improve the body rigidity near the tunnel bent portion 53 against the collision load from the vehicle front side. Therefore, the lower body structure of the vehicle 1 can further efficiently transmit the collision load from the vehicle front side to the vehicle rear side.

The bracket bent portion 123 formed between the second front portion 121 and the second rear inclined portion 122 is located on the vehicle front side of the tunnel bent portion 53. Thus, in the lower body structure of the vehicle 1, the length of the second rear inclined portion 122 can be set to be longer.

Accordingly, the inclination angle of the second rear inclined portion 122 can be set to be gentle, that is, an angle of the bracket bent portion 123 in the console bracket 10 can be set to be large. In this way, compared to a case where the inclination angle of the second rear inclined portion 122 is steep, in the lower body structure of the vehicle 1, the rigidity of the console bracket 10 can be improved. Therefore, the lower body structure of the vehicle 1 can smoothly and efficiently transmit the collision load from the vehicle front side to the vehicle rear side.

When viewed from the vehicle front-rear direction, the first portion 11 overlaps the first floor cross member 20. Accordingly, in the lower body structure of the vehicle 1, the first portions 11 on both sides in the vehicle width direction of the second portion 12 are disposed on the vehicle front side of the first floor cross member 20.

Thus, in the lower body structure of the vehicle 1, a position in the vehicle up-down direction of an axis of the center of gravity of the console bracket 10 along the vehicle front-rear direction in the vertical cross section in the vehicle width direction of the console bracket 10 can approximate that of an axis of the center of gravity of the first floor cross member 20 along the vehicle width direction in the vertical cross section in the vehicle front-rear direction of the first floor cross member 20.

In this way, in the lower body structure of the vehicle 1, the collision load from the vehicle front side can smoothly be transmitted between the second portion 12 and the first floor cross member 20 connected via the cross member flange 22 and can further efficiently be transmitted to the vehicle rear side via the first floor cross member 20 and the side sills 3.

In addition, in the lower body structure of the vehicle 1, the first portions 11 on both sides in the vehicle width direction of the second portion 12 are disposed on the vehicle front side of the first floor cross member 20. Accordingly, even when the tunnel portion 5 is attempted to move rearward during the frontal collision, the rearward movement of the tunnel portion 5 can be prevented by the console bracket 10 and the first floor cross member 20. At this time, since the collision load from the vehicle front side can be transmitted to the first floor cross member 20 via the first portions 11 in addition to the second portion 12, the lower body structure of the vehicle 1 can reliably prevent the rearward movement of the tunnel portion 5.

As illustrated in FIGS. 5A-5C, the inner surface portion 113 in the first portion 11 is formed by the inclined surface that is inclined inward in the vehicle width direction to the bottom of the vehicle, and the inner surface portion 113 is formed to have the longer inclined length to the rear of the vehicle. Thus, in the vertical cross section along the vehicle width direction, the length in the vehicle width direction on the vehicle lower side of the first portion 11 is increased, and the length in the vehicle width direction of the second portion 12 is reduced. In this way, when viewed from the vehicle front-rear direction, an overlapping area between the first portion 11 of the console bracket 10 and the first floor cross member 20 is increased. Therefore, the above-described operational effect can further reliably be exerted.

As described above, in the vertical cross section along the vehicle width direction, the second portion 12 fixed to the tunnel portion 5 and the first floor cross member 20 and transmitting the collision load from the vehicle front side has a short length in the vehicle width direction of the second portion 12. In this way, in the vertical cross section along the vehicle width direction, which is orthogonal to the vehicle front-rear direction as a load transmission direction, compared to a wide second portion, cross-sectional strength of the second portion 12 can be improved. Therefore, the second portion 12 can further efficiently transmit the collision load from the tunnel portion 5 to the first floor cross member 20.

As illustrated in FIG. 4, the horizontal placement portions 116a are provided in the first inclined portion 116 of the upper surface portion 111 in the first portion 11, and the ridgeline portions 10a passing through the horizontal placement portions 116a, which are substantially horizontal, are each formed to continue smoothly. Therefore, in cooperation with the tunnel portion 5, the console bracket 10 can function as the load transmission member that smoothly transmits the collision load from the vehicle front side to the vehicle rear side via the first floor cross member 20 and the side sills 3.

The first portion 11 is fixed to the tunnel portion 5. More specifically, the bracket flange 114 provided at the lower end of the outer surface portion 112 in the first portion 11 is joined and fixed to the side surface of the tunnel portion 5.

Accordingly, in the lower body structure of the vehicle 1, the first portions 11 on both sides in the vehicle width direction of the console bracket 10 can be fixed to the tunnel portion 5 or in the vicinity of the tunnel portion 5 as the part of the front floor panel 4.

In this way, in the lower body structure of the vehicle 1, the console bracket 10 can firmly be fixed to the front floor panel 4, and the rigidity of the front floor panel 4 and the console bracket 10 can be improved. Therefore, the lower body structure of the vehicle 1 can suppress vibration generated to the console bracket 10 and the front floor panel 4.

Furthermore, the ribs 119 are provided in the outer surface portion 112 of the first portions 11 provided on both sides in the vehicle width direction of the console bracket 10. In this way, shape maintainability of the outer surface portion 112 can be improved. As a result, the rigidity of the console bracket 10 is improved, and the rigidity of the front floor panel 4, to which the console bracket 10 is fixed by the bracket flanges 114, is also further improved. Therefore, shape maintainability of the console bracket 10 and the front floor panel 4 can be improved, and a vibration suppression effect at the time when membrane vibration is generated to the console bracket 10 and the front floor panel 4 can be exerted.

As illustrated in FIGS. 3 and 6, a slight clearance is provided between the end portion on the vehicle rear side of the console bracket 10 and the front surface of the first floor cross member 20 in the vehicle front-rear direction. Accordingly, in the vehicle front-rear direction, it is possible to dispose the console bracket 10, which covers the tunnel portion 5 from the vehicle upper side, from the vicinity of the center of the tunnel inclined portion 51 in the tunnel portion 5 to the vehicle front side of the first floor cross member 20 and to improve assemblability thereof.

In correspondence between the configuration in the disclosure and the above-described embodiment, the floor panel in the disclosure corresponds to the front floor panel 4. Similarly, hereinafter, the cross member corresponds to the first floor cross member 20, the upper surface corresponds to the upper surface portion 111, the flange corresponds to the cross member flange 22, the front portion corresponds to the second front portion 121, the rear inclined portion corresponds to the second rear inclined portion 122, and the bent portion corresponds to the bracket bent portion 123. However, the disclosure is not limited only to the configuration in the above-described embodiment, and many embodiments can be obtained.

For example, in the above-described embodiment, the bracket flange 114 provided at the lower end of the outer surface portion 112 of the first portion 11 is joined and fixed to the side surface lower portion of the tunnel portion 5, but may be fixed to a portion adjacent to the outer side in the vehicle width direction of the tunnel portion 5.

The above-described second portion 12 is fixed to the tunnel inclined portion 51 of the tunnel portion 5 and the front flange 22a of the first floor cross member 20, but may directly be fixed to the tunnel rear portion 52 of the tunnel portion 5 and the body of the first floor cross member 20.

In addition, the cross member flanges 22, 32, 42 of the floor cross members 20, 30, 40, the bracket flanges 114 of the first portions 11, and the second portion 12 are joined and fixed by welding such as spot welding, but may be fastened and fixed by bolts, fixed by rivets, or fixed by welding such as spot welding.

What is claimed is:

1. A vehicle lower body structure comprising:
a floor panel;
a tunnel portion protruding upward in a vehicle at a center position in a vehicle width direction of a floor panel and having a pair of left and right ridgeline portions extending in a vehicle front-rear direction;
a pair of left and right side sills extending in the vehicle front-rear direction at opposing lateral ends in the vehicle width direction of the floor panel;
a cross member coupling the pair of left and right side sills in the vehicle width direction across the tunnel portion and fixed to an upper surface of the floor panel; and
a console bracket having an opened cross-sectional shape covering the tunnel portion from a vehicle upper side on a vehicle front side of the cross member, opened downward in the vehicle, and extending in the vehicle front-rear direction, wherein the console bracket has a pair of left and right first portions protruding upward in the vehicle up-down direction along the pair of left and right ridgeline portions and to which console accessories are attached on upper surfaces; and a second portion located between the pair of left and right first portions and located lower in the vehicle up-down direction than the upper surfaces of the first portions, and
the second portion is fixed to the tunnel portion and the cross member.

2. The vehicle lower body structure according to claim 1, wherein
a flange fixed to the floor panel is located on the vehicle front side of the cross member, and
the first portions of the console bracket are fixed to the flange of the cross member.

3. The vehicle lower body structure according to claim 1, wherein
a flange fixed to the floor panel is located on the vehicle front side of the cross member, and
the second portion of the console bracket is fixed to the flange of the cross member.

4. The vehicle lower body structure according to claim 3, wherein
an upper surface of the tunnel portion has a tunnel inclined portion inclined upward in the vehicle up-down direction to the vehicle front side; and a tunnel rear portion disposed on the vehicle rear side of the tunnel inclined portion and extending along the vehicle front-rear direction,
the console bracket is disposed at a position covering a tunnel bent portion located between the tunnel inclined portion and the tunnel rear portion, and
the second portion is connected to the tunnel inclined portion.

5. The vehicle lower body structure according to claim 4, wherein
the second portion has a front portion extending along the vehicle front-rear direction and separated upward in the vehicle up-down direction from the upper surface of the tunnel portion; and a rear inclined portion disposed on the vehicle rear side of the front portion and inclined downward in the vehicle up-down direction to the vehicle rear side.

6. The vehicle lower body structure according to claim 5, wherein
a bent portion formed between the front portion of the second portion and the rear inclined portion of the second portion is disposed at a different position in the vehicle front-rear direction from the tunnel bent portion.

7. The vehicle lower body structure according to claim 5, wherein
a bent portion formed between the front portion of the second portion and the rear inclined portion of the second portion is disposed on the vehicle front side of the tunnel bent portion.

8. The vehicle lower body structure according to claim 1, wherein
when viewed from the vehicle front-rear direction, the first portion overlaps the cross member.

9. The vehicle lower body structure according to claim 1, wherein
the first portion is fixed to the tunnel portion or proximal the tunnel portion.

10. The vehicle lower body structure according to claim 2, wherein
the first portion is fixed to the tunnel portion or proximal the tunnel portion.

11. The vehicle lower body structure according to claim 3, wherein
the first portion is fixed to the tunnel portion or proximal the tunnel portion.

12. The vehicle lower body structure according to claim 4, wherein
the first portion is fixed to the tunnel portion or proximal the tunnel portion.

13. The vehicle lower body structure according to claim 5, wherein
the first portion is fixed to the tunnel portion or proximal the tunnel portion.

14. The vehicle lower body structure according to claim 6, wherein
the first portion is fixed to the tunnel portion or proximal the tunnel portion.

15. The vehicle lower body structure according to claim 7, wherein
the first portion is fixed to the tunnel portion or proximal the tunnel portion.

16. The vehicle lower body structure according to claim 8, wherein
the first portion is fixed to the tunnel portion or proximal the tunnel portion.
